(19) United States
(12) Patent Application Publication
(10) Pub. No.: US 2008/0074176 A1
(43) Pub. Date: Mar. 27, 2008

(54) Semiconductor integrated

(75) Inventor: Hiroshi Yamamoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/902,913

(22) Filed: Sep. 26, 2007

(30) Foreign Application Priority Data
Sep. 27, 2006 (JP) 2006-262422

(51) Int. Cl. G05F 1/10

(52) U.S. Cl. 327/544

(57) ABSTRACT

A semiconductor integrated circuit has: a first functional block connected to a first power line and a second power line; a second functional block connected to the first power line and the second power line; and a power switch provided between the first power line and the first functional block and configured to cut off electrical connection between the first power line and the first functional block at a time of a standby mode. The first functional block, the second functional block and the power switch include a first MIS transistor, a second MIS transistor and a third MIS transistor, respectively. The first to third MIS transistors are of the same conductivity type. A threshold voltage of the third MIS transistor is lower than that of the second MIS transistor.

### BACKGROUND OF THE INVENTION

1. Field of the Invention

The present invention relates to a semiconductor integrated circuit. In particular, the present invention relates to a semiconductor integrated circuit that is provided with a power switch used for power gating.

2. Description of Related Art

In the field of the semiconductor integrated circuit, reduction of electric power consumption is an important issue. The electric power consumption is classified into electric power consumption during an active mode and electric power consumption during a standby mode. The electric power consumption during the standby mode among them depends on, for example, sub-threshold leakage current in a MOS transistor. The sub-threshold leakage current is a leakage current that flows between a source and a drain with the MOS transistor being OFF.

“Power gating” is known as a technique for reducing the electric power consumption during the standby mode. The power gating is a technique that cuts off power supply to a functional block which does not operate at the time of the standby mode. For that purpose, a power switch transistor is provided between the functional block as a target of the power gating and the power source. At the time of the standby mode, the power switch transistor is turned OFF and hence the power supply to the functional block as the target of power gating is cut off. As a result, the leakage current within the functional block is greatly reduced and thus the electric power consumption during the standby mode is reduced.

In general, a threshold voltage of a MOS transistor that constitutes the functional block as the target of power gating is designed to be low. On the other hand, a threshold voltage of the power switch transistor is designed to be higher than the threshold voltage of the MOS transistor in the functional block. Consequently, not only the sub-threshold leakage current during the standby mode is reduced but also high-speed operation of the functional block during the active mode can be achieved (refer to Japanese Laid Open Patent Application JP-A-Heisei 6-29834 and Japanese Laid Open Patent Application JP-P2006-165065A, for example).

It should be noted here that a threshold voltage of an enhancement-type NMOS transistor is positive while a threshold voltage of an enhancement-type PMOS transistor is negative. In the present specification, for simplicity, “the absolute value of the threshold voltage being large” is simply referred to as “the threshold voltage being high”, and “the absolute value of the threshold voltage being small” is simply referred to as “the threshold voltage being low”, regardless of the threshold voltage being positive or negative. In other words, the threshold voltage is determined to be high or low depending on whether the absolute value of the threshold voltage is large or small, regardless of the polarity (positive and negative).

In order to provide an LSI with MOS transistors having different threshold voltages as described above, it is necessary to control the threshold voltages of the respective MOS transistors. Here, it is known that the threshold voltage depends on impurity concentration in a channel region (referred to as “channel impurity concentration” or “substrate impurity concentration”). More specifically, in a case of an enhancement-type MOS transistor, the threshold voltage becomes higher as the channel impurity concentration becomes higher, while the threshold voltage becomes lower as the channel impurity concentration becomes lower. It is therefore possible to control the threshold voltage by adjusting the channel impurity concentration.

The inventor of the present application has recognized and considered the following points. That is, not only the sub-threshold leakage current but also “substrate current” flows at the time of the standby mode. The substrate current at the time of the standby mode includes a junction leakage current, a GIDL (Gate Induced Drain Leakage) current and so on. The junction leakage current is a current that flows when a reverse bias is applied to a p-n junction. The GIDL current is a current that flows from a drain to a substrate when a MOS transistor is in the OFF state, due to influence of gate potential on the edge of the drain below a gate electrode.

The substrate current mentioned above becomes larger as the channel impurity concentration becomes higher. In other words, the substrate current tends to be larger as the threshold voltage becomes higher. This tendency is opposite to the case of the sub-threshold leakage current. That is to say, the sub-threshold leakage current becomes smaller while the substrate current becomes larger, as the channel impurity concentration becomes higher.

In considering the electric power consumption during the standby mode, only the sub-threshold leakage current is insufficient, and the substrate current should also be taken into consideration. In a case where a MOS transistor with a high threshold voltage is used as the power switch transistor, the sub-threshold leakage current is certainly reduced. However, the total leakage current including the sub-threshold leakage current and the substrate current may be increased as a whole.

### SUMMARY

In one embodiment of the present invention, a semiconductor integrated circuit has: a first functional block, a second functional block and a power switch. Each of the first functional block and the second functional block is connected to a first power line and a second power line. The power switch is provided between the first power line and the first functional block, and cuts off electrical connection between the first power line and the first functional block at a time of a standby mode. The first functional block, the second functional block and the power switch include a first MIS transistor, a second MIS transistor and a third MIS transistor, respectively. The first to third MIS transistors are of the same conductivity type. A threshold voltage of the third MIS transistor is lower than a threshold voltage of the second MIS transistor.

As described above, an internal circuit of the semiconductor integrated circuit is provided with a plurality kinds of MIS transistors having the same conductivity type and different threshold voltages. Among them, there is the second MIS transistor whose threshold voltage is higher than that of the third MIS transistor used for the power switch. In other words, a MIS transistor other than one having the maximum threshold voltage among the plurality kinds of MIS transistors is applied to the power switch. Therefore, increase in the substrate current within the power switch at the time of the standby mode is suppressed. As a result, the total leakage current including the sub-threshold leakage current and the substrate current is reduced as a whole.

According to the semiconductor integrated circuit of the present invention, the total leakage current including the sub-threshold leakage current and the substrate current is reduced as a whole at the time of the standby mode. As a result, the electric power consumption during the standby mode is reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit block diagram showing an example of a configuration of a semiconductor integrated circuit according to an embodiment of the present invention;

FIG. 2 is a circuit block diagram showing another example of a configuration of a semiconductor integrated circuit according to the embodiment of the present invention;

FIG. 3 is a conceptual diagram showing a structure of a MOS transistor and leakage currents at a time of a standby mode; and

FIG. 4 is a graph showing relationship between leakage currents and a threshold voltage and a substrate potential.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

1. Configuration

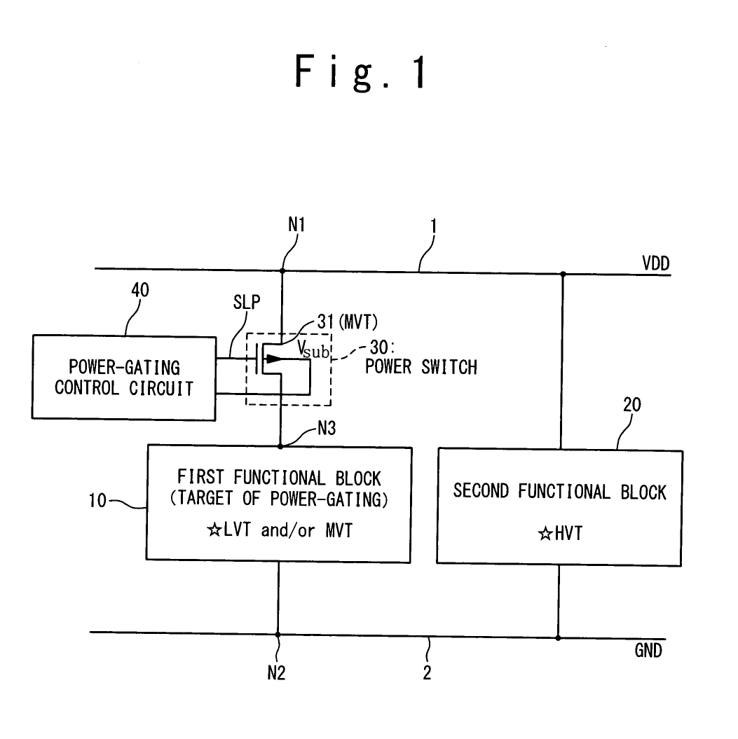

FIG. 1 shows an example of a configuration of a semiconductor integrated circuit according to an embodiment. In particular, FIG. 1 schematically shows a part of an internal circuit of the semiconductor integrated circuit. In FIG. 1, the internal circuit of the semiconductor integrated circuit includes a VDD power line 1, a GND power line 2, a first functional block 10, a second functional block 20, a power switch 30 and a power-gating control circuit 40.

The VDD power line 1 is a power line for supplying power source potential VDD to the internal circuit. The GND power line 2 is a power line for supplying ground potential GND to the internal circuit.

The first functional block 10 has a logic circuit and is constituted by CMOS transistors that include a PMOS transistor and an NMOS transistor. The first functional block 10 is connected to the VDD power line 1 (node N1) and the GND power line 2 (node N2), and operates by using electric power supplied from the power lines 1 and 2. Here, the first functional block 10 is connected to the VDD power line 1 through the power switch 30 for the power gating. That is to say, the first functional block 10 is a target of the power gating.

The second functional block 20 has a logic circuit and is constituted by CMOS transistors that include a PMOS transistor and an NMOS transistor. The second functional block 20 is connected to the VDD power line 1 (node N1) and the GND power line 2 (node N2), and operates by using electric power supplied from the power lines 1 and 2. Here, the second functional block 20 is not connected to the power switch 30 for the power gating. That is to say, the second functional block 20 is not a target of the power gating.

The power switch 30 is connected between the VDD power line 1 (node N1) and the first functional block 10 (node N3). The power switch 30 is a power switch used for the power gating, and cuts off electrical connection between the VDD power line 1 and the first functional block 10 at a time of a standby mode. That is to say, the power switch 30 cuts (shuts) off power supply to the first functional block 10 at the time of the standby mode.

More specifically, the power switch 30 has a power switch transistor 31. The power switch transistor 31 is a PMOS transistor. In the standby mode, the power switch transistor 31 is turned OFF and thereby the electric power supply to the first functional block 10 is cut (shut) off. Also, the power switch 30 may have a plurality of power switch transistors 31 provided in parallel between the node N1 and the node N3. In that case, the plurality of power switch transistors 31 are all turned OFF at the time of the standby mode.

The power-gating control circuit 40 is a circuit for controlling the operation of the power switch 30 and is connected to the power switch 30. More specifically, the power-gating control circuit 40 supplies a sleep signal SLP that controls ON/OFF of the power switch transistor 31 to a gate electrode of the power switch transistor 31. Moreover, the power-gating control circuit 40 controls a substrate potential (well potential) Vsub applied to a substrate (well) on which the power switch transistor 31 is formed. The power-gating control circuit 40 is configured in the same way as the second functional block 20, since the power-gating control circuit 40 needs to operate even when the power switch is in the OFF state.

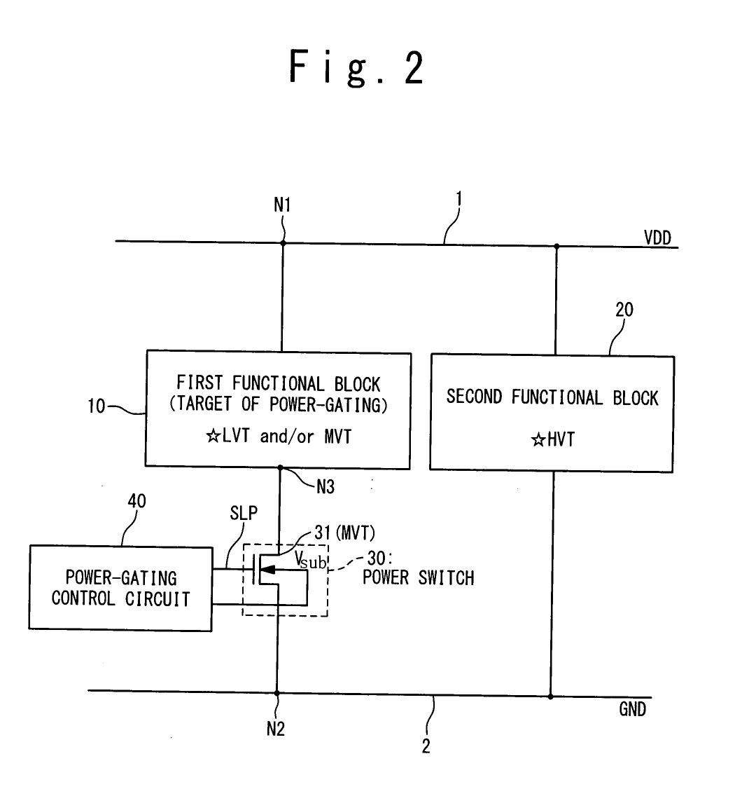

FIG. 2 shows another example of a configuration of a semiconductor integrated circuit according to the present embodiment. In particular, FIG. 2 schematically shows a part of an internal circuit of the semiconductor integrated circuit. In FIG. 2, the same reference numerals are given to the same components as those in FIG. 1, and an overlapping description will be appropriately omitted.

In FIG. 2, the first functional block 10 as the target of power gating is connected to the GND power line 2 (node N2) through the power switch 30. That is to say, the power switch 30 is connected between the GND power line 2 (node N2) and the first functional block 10 (node N3). The power switch 30 cuts off electrical connection between the GND power line 2 and the first functional block 10 at the time of the standby mode. More specifically, the power switch 30 has a power switch transistor 31, which is an NMOS transistor. In the standby mode, the power switch transistor 31 is turned OFF and thereby the electric power supply to the first functional block 10 is cut (shut) off. Also, the power switch 30 may have a plurality of power switch transistors 31 provided in parallel between the node N2 and the node N3. In that case, the plurality of power switch transistors 31 are all turned OFF at the time of the standby mode.

Also, the power switch 30 may be provided on both of the VDD side and the GND side.

2. Operation

Operations of the semiconductor integrated circuit shown in FIG. 1 or FIG. 2 are as follows. At a time of an active mode, the power-gating control circuit 40 deactivates the sleep signal SLP. In this case, the power switch transistor 31 is turned ON. As a result, the first functional block 10 is electrically connected to both the power lines 1 and 2. Additionally, it is known that a threshold voltage of a MOS transistor depends on the substrate potential Vsub. Therefore, the power-gating control circuit 40 may control the substrate potential Vsub such that the threshold voltage of the power switch transistor 31 is decreased.

On the other hand, at a time of the standby mode, the power-gating control circuit 40 activates the sleep signal SLP. In this case, the power switch transistor 31 is turned OFF. As a result, the electrical connection between the first functional block 10 and the power line 1 or the power line 2 is cut off. Since the electric power supply to the first functional block 10 is cut (shut) off, the leakage current within the first functional block 10 is reduced and thus the electric power consumption is reduced.

Moreover, at the time of the standby mode, the power-gating control circuit 40 may control the substrate potential Vsub such that the threshold voltage of the power switch transistor 31 is increased. In this case, in the power switch transistor 31, the substrate potential Vsub is different from a source potential. In the case where the power switch transistor 31 is an NMOS transistor, the substrate potential Vsub (e.g. −1 V) is set lower than the source potential (e.g. 0 V). In the case where the power switch transistor 31 is a PMOS transistor, the substrate potential Vsub (e.g. 2 V) is set higher than the source potential (e.g. 1 V). By controlling the substrate potential Vsub in this manner, the threshold voltage is increased and the sub-threshold leakage current is reduced.

3. Plurality Kinds of MOS Transistors

The internal circuit of the semiconductor integrated circuit according to the present embodiment is provided with a plurality kinds of MOS transistors having the same conductivity type but different threshold voltages. For example, three kinds of MOS transistors having the same conductivity type, which are a high-Vt transistor HVT, an intermediate-Vt transistor MVT and a low-Vt transistor LVT, are used. The high-Vt transistor HVT is a MOS transistor whose threshold voltage is the maximum (highest) among them. The low-Vt transistor LVT is a MOS transistor whose threshold voltage is the minimum (lowest) among them. The intermediate-Vt transistor MVT is a MOS transistor whose threshold voltage is between those of HVT and LVT.

It should be noted that the threshold voltage is a gate-source voltage at a point when current begins to flow between the source and the drain, when the gate-source voltage is gradually increased. “The threshold voltage being high” means that the gate-source voltage at that point is large. On the other hand, “the threshold voltage being low” means that the gate-source voltage at that point is small. In a case of a NMOS transistor, for example, the threshold voltage of the high-Vt transistor HVT is higher than that of the intermediate-Vt transistor MVT. In a case of a PMOS transistor, the source potential is the power source potential VDD and the threshold voltage is negative. However, when considering in terms of absolute value, the threshold voltage of the high-Vt transistor HVT is higher than that of the intermediate-Vt transistor MVT.

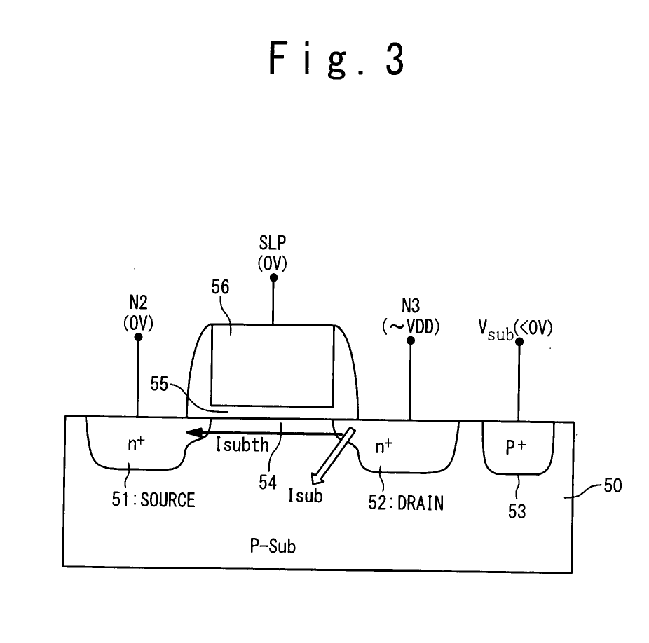

FIG. 3 conceptually shows a structure of a typical MOS transistor. A MOS (Metal Oxide Semiconductor) transistor is one kind of a MIS (Metal Insulator Semiconductor) transistor. FIG. 3 shows a structure of an NMOS transistor as an example. As shown in FIG. 3, a source 51, a drain 52, and a P-type diffusion layer 53 as a back-gate are formed in a P-type semiconductor substrate (P-type well) 50. A channel region 54 is formed between the source 51 and the drain 52 in the P-type semiconductor substrate 50. A gate electrode 56 is formed on the channel region 54 through a gate insulating film 55.

In the present embodiment, the threshold voltage of the MOS transistor is controlled mainly by adjusting impurity concentration in the channel region 54 (channel impurity concentration). The threshold voltage becomes higher as the channel impurity concentration becomes higher. On the other hand, the threshold voltage becomes lower as the channel impurity concentration becomes lower. Therefore, the respective channel impurity concentration of the plurality kinds of MOS transistors HVT, MVT and LVT are different from each other. The channel impurity concentration of the high-Vt transistor HVT is higher than the channel impurity concentration of the intermediate-Vt transistor MVT. The channel impurity concentration of the intermediate-Vt transistor MVT is higher than the channel impurity concentration of the low-Vt transistor LVT. With regard to the plurality kinds of MOS transistors HVT, MVT and LVT, parameters other than the channel impurity concentration can be the same. For example, thicknesses of the gate insulating films 55 of the respective MOS transistors HVT, MVT and LVT can be the same.

Here, let us consider a state of the power switch transistor 31 in the standby mode. For example, let us consider the power switch transistor 31 shown in FIG. 2. The power switch transistor 31 is an NMOS transistor and is turned OFF at the time of the standby mode. As shown in FIGS. 2 and 3, the source 51 is connected to the node N2 and hence the source potential is 0 V. The sleep signal SLP of Low-level is applied to the gate electrode 56 and the gate potential is 0 V. The drain 52 is connected to the node N3. Since a resistance value of the first functional block 10 as a whole is much smaller than a resistance value of the power switch transistor 31, the potential at the node N3 is approximately the power source potential VDD. That is to say, the drain potential is approximately the power source potential VDD. Therefore, a reverse bias is applied to the p-n junction of the semiconductor substrate 50 and the drain 52. When the substrate potential control is performed, the substrate potential Vsub is set to be smaller than 0 V and the reverse bias is further increased.

In the standby state, a sub-threshold leakage current Isubth flows between the source 51 and the drain 52. The sub-threshold leakage current Isubth decreases as the threshold voltage becomes higher. Furthermore, a substrate current Isub flows in addition to the sub-threshold leakage current Isubth. The substrate current includes a junction leakage current and a GIDL current. The junction leakage current is a current that flows when the reverse bias is applied to the p-n junction. The GIDL current is a current that flows from the drain 52 to the substrate 50 due to influence of the gate potential on the edge of the drain 52 below the gate electrode 56. The substrate current Isub increases as the channel impurity concentration becomes higher. Moreover, the substrate current Isub increases as the controlled amount of the substrate potential Vsub becomes larger. As a leakage current Ileak during the standby mode, the sum of the sub-threshold leakage current Isubth and the substrate current Isub mentioned above needs to be considered.

The case of the NMOS transistor has been exemplified above, and the same applies to the case of the PMOS transistor as well when the absolute value of the threshold voltage is considered.

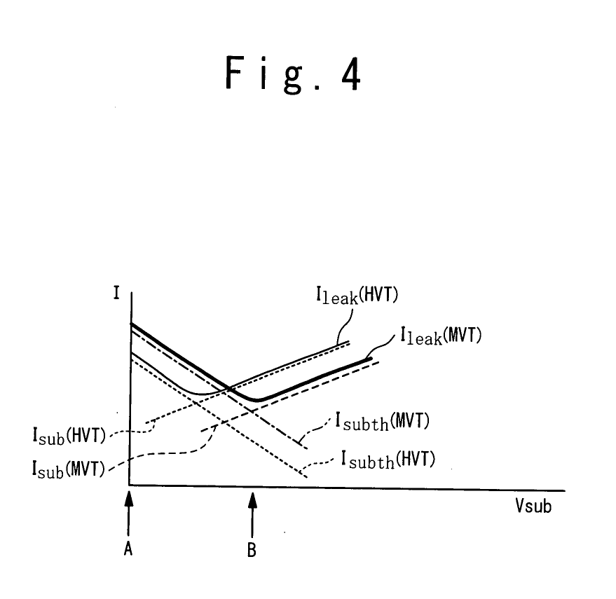

FIG. 4 shows relationship between the leakage current Ileak in the power switch transistor 31 and its threshold voltage and the substrate potential Vsub. The vertical axis indicates the magnitude of current, while the horizontal axis indicates the controlled amount of the substrate potential Vsub. In the case of the NMOS transistor, the horizontal axis indicates how much lower the substrate potential Vsub is than the source potential (GND). In the case of the PMOS transistor, the horizontal axis indicates how much higher the substrate potential Vsub is than the source potential (VDD). In general, the threshold voltage becomes higher as the controlled amount of the substrate potential Vsub increases. FIG. 4 also shows the sub-threshold leakage current Isubth, the substrate current Isub and the total leakage current Ileak (=Isubth+Isub), with respect to each of the high-Vt transistor HVT and the intermediate-Vt transistor MVT.

The sub-threshold leakage current Isubth becomes smaller as the threshold voltage becomes higher. Therefore, the sub-threshold leakage current Isubth(HVT) in the high-Vt transistor HVT is totally smaller than the sub-threshold leakage current Isubth(MVT) in the intermediate-Vt transistor MVT. Moreover, both of the sub-threshold leakage currents Isubth(HVT) and Isubth(MVT) tend to decrease as the controlled amount of the substrate potential Vsub is increased.

On the other hand, the substrate current Isub increases as the channel impurity concentration becomes higher. Therefore, the substrate current Isub(HVT) in the high-Vt transistor HVT is totally larger than the substrate current Isub(MVT) in the intermediate-Vt transistor MVT. Moreover, as the controlled amount of the substrate potential Vsub is increased, the reverse bias applied to the p-n junction and the electric field applied to the edge of the drain becomes stronger. Therefore, both of the substrate currents Isub(HVT) and Isub(MVT) tend to increase as the controlled amount of the substrate potential Vsub is increased.

As explained above and shown in FIG. 4, the change tendencies of the sub-threshold leakage current Isubth and the substrate current Isub are totally opposite to each other. Therefore, when considering the leakage current Ileak (=Isubth+Isub) as a whole, the high-Vt transistor HVT is not always suitable for suppressing the leakage current Ileak. In some cases, the total leakage current Ileak(HVT) in the high-Vt transistor HVT becomes larger than the total leakage current Ileak(MVT) in the intermediate-Vt transistor MVT. In particular, when the control of the substrate potential Vsub is carried out, the substrate current Isub becomes conspicuous and thus the total leakage current Ileak(HVT) is more likely to become larger than the total leakage current Ileak(MVT). For example, at a point “A” in FIG. 4 where the substrate potential control is not performed, the leakage current Ileak(HVT) is smaller than the leakage current Ileak(MVT). At a point “B” in FIG. 4, however, the leakage current Ileak(HVT) is larger than the leakage current Ileak(MVT). That is to say, the electric power consumption during the standby mode becomes larger in the case of the high-Vt transistor HVT as compared with the case of the intermediate-Vt transistor MVT.

Therefore, according to the present embodiment, the intermediate-Vt transistor MVT instead of the typically-used high-Vt transistor HVT is used as the power switch transistor 31. In other words, the power switch 30 according to the present embodiment is constituted by a transistor other than the MOS transistor (HVT) having the maximum (highest) threshold voltage. A MOS transistor whose threshold voltage is higher than that of the power switch transistor 31 is used in another area of the internal circuit. For example, as shown in FIGS. 1 and 2, the second functional block 20 is constituted by the high-Vt transistor HVT. The power switch transistor 31 included in the power switch 30 is the intermediate-Vt transistor MVT. Consequently, the total leakage current Ileak at the time of the standby mode can be reduced, as compared with the case where the power switch transistor 31 is the high-Vt transistor HVT.

Also, as shown in FIGS. 1 and 2, the first functional block 10 as the target of power gating is constituted by the low-Vt transistor LVT or/and the intermediate-Vt transistor MVT. That is to say, the threshold voltage of the MOS transistor included in the first functional block 10 is equal to or lower than the threshold voltage of the power switch transistor 31 (MVT). As a result, not only leakage currents within the first functional block 10 during the standby mode are effectively suppressed but also high-speed operation of the first functional block 10 during the active mode can be achieved.

4. Effects

As described above, the internal circuit of the semiconductor integrated circuit according to the present embodiment is provided with the plurality kinds of MIS transistors (LVT, MVT, HVT) having the same conductivity type and different threshold voltages. Among them, there is a MIS transistor (HVT) whose threshold voltage is higher than that of the power switch transistor 31 (MVT). In other words, a MIS transistor other than the HVT having the maximum threshold voltage among the plurality kinds of MIS transistors (LVT, MVT, HVT) is used as the power switch transistor 31.

Therefore, increase in the substrate current Isub within the power switch 30 is suppressed at the time of the standby mode. As a result, the leakage current Ileak including the sub-threshold leakage current Isubth and the substrate current Isub is reduced as a whole. Thus, the electric power consumption during the standby mode is reduced. In a case where the substrate potential Vsub is controlled at the time of the standby mode, the substrate current Isub tends to increase and therefore the present invention is particularly effective.

It is apparent that the present invention is not limited to the above embodiments and may be modified and changed without departing from the scope and spirit of the invention.

What is claimed is:

1. A semiconductor integrated circuit comprising:
a first functional block connected to a first power line and a second power line;
a second functional block connected to said first power line and said second power line; and
a power switch provided between said first power line and said first functional block and configured to cut off electrical connection between said first power line and said first functional block at a time of a standby mode,
wherein said first functional block, said second functional block and said power switch include a first MIS transistor, a second MIS transistor and a third MIS transistor, respectively, and said first to third MIS transistors are of a same conductivity type,
wherein a threshold voltage of said third MIS transistor is lower than a threshold voltage of said second MIS transistor.

2. The semiconductor integrated circuit according to claim 1,
wherein channel impurity concentration of said third MIS transistor is lower than channel impurity concentration of said second MIS transistor.

3. The semiconductor integrated circuit according to claim 1,
wherein at a time of said standby mode, a substrate potential and a source potential in said third MIS transistor are different from each other.

4. The semiconductor integrated circuit according to claim 2,
wherein at a time of said standby mode, a substrate potential and a source potential in said third MIS transistor are different from each other.

5. The semiconductor integrated circuit according to claim 1,
wherein said threshold voltage of said third MIS transistor is equal to or higher than a threshold voltage of said first MIS transistor.

6. A semiconductor integrated circuit comprising:
a plurality kinds of MIS transistors provided in an internal circuit and having a same conductivity type and different threshold voltages; and
a power switch transistor provided in said internal circuit and configured to cut off power supply to a functional block at a time of a standby mode,
wherein said power switch transistor is a MIS transistor other than one having a maximum threshold voltage among said plurality kinds of MIS transistors.

7. The semiconductor integrated circuit according to claim 6,
wherein respective channel impurity concentration of said plurality kinds of MIS transistors are different from each other.

8. The semiconductor integrated circuit according to claim 6,
wherein at a time of said standby mode, a substrate potential and a source potential in said power switch transistor are different from each other.

9. The semiconductor integrated circuit according to claim 7,
wherein at a time of said standby mode, a substrate potential and a source potential in said power switch transistor are different from each other.
